(19) United States
(12) Patent Application Publication
(10) Pub. No.: US 2026/0016404 A1
(43) Pub. Date: Jan. 15, 2026

(54) PORTABLE MOISTURE SENSING DEVICE FOR RAPID DETERMINATION OF SEED MOISTURE CONTENT AND SEED HARVEST TIMING

(71) Applicant: Oregon State University, Corvallis, OR (US)

(72) Inventors: Jing Zhou, Corvallis, OR (US); Nicole P. Anderson, Corvallis, OR (US); David Maliszewski, Corvallis, OR (US); Thomas Chastain, Corvallis, OR (US); Marshall Garrett, Corvallis, OR (US); Logan Paul Snell, Corvallis, OR (US)

(73) Assignee: Oregon State University, Corvallis, OR (US)

(21) Appl. No.: 19/268,912

(22) Filed: Jul. 14, 2025

Related U.S. Application Data
(60) Provisional application No. 63/671,710, filed on Jul. 15, 2024.

(51) Int. Cl. G01N 21/3554; A01F 12/18; A01F 12/44; G01N 21/359

(52) U.S. Cl. CPC G01N 21/3554; A01F 12/18; A01F 12/446; G01N 21/359; G01N 2201/062

(57) ABSTRACT

Described herein is a portable seed moisture content measuring system based on infrared reflection spectroscopy. The system comprises a portable SMC readout console and a portable seed threshing apparatus. The portable SMC readout console is a handheld device comprising a near-infrared sensor fixture. The sensor fixture comprises a base plate, one or more light emitting diodes (LEDs) on the base plate and oriented obliquely, The LEDs are configured to emit a beam of near infrared light to a seed sample and a photodetector disposed at a center of the base plate receives the reflected light. The portable seed threshing apparatus provides clean seeds for the SMC readout console.

### CLAIM OF PRIORITY

This application claims priority to U.S. provisional patent application Ser. No. 63/671,710 filed Jul. 15, 2024, titled “PORTABLE MOISTURE SENSING DEVICE FOR RAPID DETERMINATION OF SEED MOISTURE CONTENT AND SEED HARVEST TIMING,” which is incorporated by reference in its entirety.

### BACKGROUND

Grass seed farmers, crop advisors, seed companies, and end user customers of such seed products all have a vested interest in the seeds being harvested at appropriate timing to maximize seed yield and ensure good seed quality (% germination) of such seed. Seed moisture content (SMC) is the most reliable indicator of optimal harvest timing in many seed crops. Harvesting within the correct range of SMC will maximize seed yield and minimize losses of seed to shattering during the harvest process. Cutting too early at high SMC shortens the seed fill period leading to immature seed and reduced seed size and weight. Also, seeds with high SMC have reduced longevity in storage and lower seed germination. Cutting too late at low SMC can reduce seed yield as a result of shattering losses. Therefore, to identify the optimal timing, seed producers, crop advisors, and seed companies must test for SMC to determine optimal harvest timing. Historically, measuring and monitoring SMC in grass seed crops has been done through a labor-intensive and time-consuming process.

Various seed industries, including the grass seed industry, have historically adopted a casual, sometimes haphazard approach to collecting and leveraging information that might help seed producers improve the quantity and quality of their harvested seed. The most vital information a farmer can gather is an accurate reading of the SMC that is representative of the seeds being grown, across their fields. Collecting that information is arduous and time consuming, which has resulted in inadequate testing or testing too late, when the SMC has already fallen below recommended levels. A more efficient data collection process would provide seed producers with more timely and comprehensive method to determine the optimal time to harvest their crops.

### BRIEF DESCRIPTION OF DRAWINGS

Material described herein is illustrated by way of example and not by way of limitation in accompanying figures. For simplicity and clarity of illustration, elements illustrated in figures are not necessarily drawn to scale and exact locations. For example, dimensions of some elements can be exaggerated relative to other elements for clarity. Also, various physical features can be represented in their simplified “ideal” forms and geometries for clarity of discussion, but it is nevertheless to be understood that practical embodiments can only approximate illustrated ideals. For example, smooth surfaces and square intersections can be drawn in disregard of finite roughness, corner-rounding, and imperfect angular intersections characteristic of structures formed by nanofabrication techniques. Further, where considered appropriate, reference labels have been repeated among figures to indicate corresponding or analogous elements.

FIG. 1A illustrates a cross-sectional view of a sensor fixture, in accordance with at least one embodiment.

FIG. 1B illustrates a plan view of the sensor fixture of FIG. 1A, in accordance with at least one embodiment.

FIG. 2A illustrates a plan view of a rear panel of portable SMC readout console in accordance with at least one embodiment.

FIG. 2B illustrates a plan view of a front panel of the portable SMC readout console shown in FIG. 2A, in accordance with at least one embodiment.

FIG. 2C illustrates a view of a side panel of the portable SMC readout console shown in FIG. 2A, in accordance with at least one embodiment.

FIG. 2A illustrates a top plan view of an SMC readout console having a gaming console configuration or gaming-style interaction with a user, in accordance with at least one embodiment.

FIG. 2B illustrates a profile view of the SMC readout console shown in FIG. 2D with seed cup detached, in accordance with at least one embodiment.

FIG. 2C illustrates a 3D exploded view of a coupling port assembly that is part of SMC readout console shown in FIGS. 2A and 2B, showing a sensor fixture, LEDs, photodetector, coupling port, optical flat and seed cup, in accordance with at least one embodiment.

FIG. 3 illustrates a block diagram of an electronic control circuitry for the portable SMC readout console shown in FIGS. 2A-2C, in accordance with at least one embodiment.

FIG. 4 illustrates an isometric view of a portable seed threshing apparatus, in accordance with at least one embodiment.

FIG. 5 illustrates a block diagram of a portable SMC measurement system comprising the portable SMC readout console shown in FIGS. 2A-2C and portable seed threshing apparatus shown in FIG. 4, in accordance with at least one embodiment.

FIG. 6 illustrates a flowchart summarizing an exemplary method for measuring SMC of seed samples using the portable SMC measurement system shown in FIG. 5, in accordance with at least one embodiment.

FIG. 7 illustrates a processor system with a machine-readable storage medium having machine-readable instructions that when executed cause a circuit board of a control unit of the portable SMC readout console shown in FIGS. 2A-2C, to execute machine-readable instructions according to the method summarized by the method summarized in FIG. 6, in accordance with at least one embodiment.

### DETAILED DESCRIPTION

Here, some methods and devices may be shown in block diagram form, rather than in detail, to avoid obscuring present disclosure. Reference throughout this specification to “an embodiment” or “one embodiment” or “some embodiments” means that a particular feature, structure, function, or characteristic described in connection with an embodiment is included in at least one embodiment of disclosure. Thus, appearances of phrase “in an embodiment” or “in one embodiment,” “in at least one embodiment,” or “some embodiments” in various places throughout this specification are not necessarily referring to same embodiment of disclosure. Furthermore, particular features, structures, functions, or characteristics can be combined in any suitable manner in one or more embodiments. For example, a first embodiment can be combined with a second embodiment anywhere particular features, structures, functions, or characteristics associated with two embodiments are not mutually exclusive. A list of definitions follows, whereby following definitions may provide or augment literal support for claims.

As used in herein, singular forms “a,” “an,” and “the” are intended to include plural forms as well, unless context clearly indicates otherwise. It will also be understood that term “and/or” as used herein refers to and encompasses all possible combinations of one or more of associated listed items.

Here, “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical, electrical or in magnetic contact with each other, and/or that two or more elements co-operate or interact with each other (e.g., as in a cause an effect relationship). Coupled may also have the meaning of non-mechanical contact or connection. Coupling may also have the meaning of thermal connectivity, where one object may be a heat source and another object may be a heat sink, either in thermal equilibrium with each other or subject to a common conductive, convective or radiative heat flow between them; electrically coupled, where objects may be connected electrically in an electric or electronic circuit and a current flow may be induced by application of a voltage between the electrically interconnected objects or by an electric field between mechanically coupled or isolated objects; magnetically, where two mechanically coupled or isolated objects mutually share a common magnetic field flux; and fluidically, where objects such as vessels and conduits may share a common gas or liquid fluid that is static or flowing.

Here, a device that is “configured to” perform a task or function may be configured (e.g., programmed and/or hardwired) at a time of manufacturing by a manufacturer to perform the function. In at least one example, the device may be configurable (or reconfigurable) by a user after manufacturing to perform the function and/or other additional or alternative functions. In at least one example, the configuring may be through firmware and/or software programming of the device, through a construction and/or layout of hardware components and interconnections of the device, or a combination thereof.

Here, “between” may be employed in context of z-axis, x-axis or y-axis of a device. A material that is between two other materials may be in contact with one or both of those materials. In another example, a material that is between two or other material may be separated from both of other two materials by one or more intervening materials. A material “between” two other materials may therefore be in contact with either of other two materials. In another example, a material “between” two other materials may be coupled to other two materials through an intervening material. A device that is between two other devices may be directly connected to one or both of those devices. In another example, a device that is between two other devices may be separated from both of other two devices by one or more intervening devices.

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by term “at least one of” or “one or more of” can mean any combination of listed terms.

Here, “left,” “right,” “front,” “back,” “top,” “bottom,” “over,” “under,” and similar terms are used for descriptive purposes and not necessarily for describing permanent relative positions. For example, terms “over,” “under,” “front side,” “back side,” “top,” “bottom,” “over,” “under,” and “on” as used herein refer to a relative position of one component, structure, or material with respect to other referenced components, structures, or materials within a device, where such physical relationships are noteworthy. These terms are employed herein for descriptive purposes only and predominantly within context of a device z-axis and therefore may be relative to an orientation of a device. Hence, a first material “over” a second material in context of a figure provided herein may also be “under” second material if device is oriented upside-down relative to context of figure provided. Similar distinctions are to be made in context of component assemblies.

Here, “adjacent” can generally refer to a position of a thing being next to (e.g., immediately next to or close to with one or more things between them) or adjoining another thing (e.g., abutting it).

Unless otherwise specified in explicit context of their use, terms “substantially equal,” “about equal,” and “approximately equal” can generally mean that there is no more than incidental variation between two things so described. In at least one embodiment, such variation is no more than +/−10% of referred value.

Described herein is a portable seed moisture content (SMC) measurement apparatus. In a first aspect, the portable SMC measurement apparatus comprises a moisture measurement unit. In at least one embodiment the handheld moisture measurement unit comprises an enclosure configured for hand-held or benchtop operation. In at least one embodiment, the enclosure has a gaming console shape, housing one or more electronic circuits, including a microprocessor, a battery power management circuit, a LED driver circuit and a photodiode current to voltage converter circuit. In other embodiments, the enclosure may have a substantially rectangular shape. A touchscreen display is disposed on a first side of the enclosure. In at least one embodiment, a near infrared (NIR) source and photodetector unit are combined onto a sensor fixture that is disposed on a side of the enclosure opposite the interactive display, in accordance with at least one embodiment. In other embodiments, the sensor fixture is disposed on the same side of the enclosure as the interactive display. In at least one embodiment, the sensor fixture is configured to receive a seed sample cup. In at least one embodiment, the sensor fixture has a threaded rim that extends above the enclosure surface to which the seed sample cup may be attached. In other embodiments, the sensor fixture comprises a rim having bayonet mounting slots, where the sample cup has corresponding tabs that fit into the bayonet mounting slots and may be mounted and removed by a simple twisting action.

In at least one embodiment, the NIR source comprises a plurality of near-infrared light-emitting diodes (LEDs) arranged in an array, and a photodetector positioned at the center of the LED array. In at least one embodiment, the photodetector is a photodiode. In at least one embodiment, the plurality of LEDs is arrayed in a circular array. In at least one embodiment, the individual LEDs are tilted inwardly toward the center of the array. For maximum sensitivity of the device, the spectral output of the LEDs is selected to cover a portion of the NIR absorption spectrum most sensitive to changes in seed moisture content. For example, a spectral range of 1200 to 1500 nm may exhibit a high sensitivity to changes in SMC relative to other portions of the NIR spectrum (750 nm to about 2000 nm). Inasmuch as LED spectral characteristics are generally narrow-banded (e.g., bandwidth <150 nm), in at least one embodiment, the 1200 nm 1500 nm range of reflected NIR light may be covered by incorporation of two or more LED groups into the LED array. In at least one embodiment, each LED group has overlapping spectral output. For example, the peak wavelengths of each LED group may be separated by 100 to 200 nm of one another to allow sufficient overlap of spectral bandwidth. The spectral overlap can provide continuous spectral coverage within the specified broad NIR wavelength range (e.g., 1200 nm-1500 nm) that exhibits a high sensitivity to changes in SMC. In at least one embodiment, the LED array comprises two LED groups, whereby a first group has a peak wavelength of substantially 1300 nm and a second group has peak wavelength of 1450 nm. In at least one embodiment, both LED groups have sufficient bandwidth to enable sufficient spectral overlap, providing continuous spectral coverage of the 1200 nm to 1500 nm range. In at least one embodiment, each LED group has four LEDs arranged in a circular array. Thus, in at least one embodiment, the LED array contains eight LEDs, with individual LEDs from each group arranged alternatively within a circular array. In other embodiments, the sensor fixture may incorporate other suitable numbers of LEDs.

In at least one embodiment, the individual LEDs of the array may be tilted at an angle with respect to a vector perpendicular to the plane of the array. A circular array of points of incidence from each LED beam is thus formed on a plane of incidence located below the plane of the LED array. Due to the tilt angle of the LEDs, each point of incidence is located along a radius extending between the LED source and the center of the array: Light shining from each LED is reflected from the incident point to the photodetector at the center of the LED array. In at least one embodiment, an array of illuminated points on the plane of incidence is formed. In at least one embodiment, the angle of incidence of the NIR light incident on the plane of incidence allows NIR light reflected from each of the points of incidence to impinge on the photodetector located at the center of the LED array.

When the seed sample container is mounted on the SMC measurement apparatus, the plane of incidence coincides with a specific depth within the seed sample container. The depth is ensured by a piece of UV quartz glass between the SMC measurement apparatus and the seed sample container. According to at least one embodiment, the sample cup is fully filled by seeds harvested from a single species or multiple species of grass or other plant. Seeds will be compressed against the UV quartz glass when the sample cup is fully mounted on the SMC measurement apparatus. NIR light intensity reflected from the plane of incidence within the sample cup is inversely correlated to the moisture content of the seeds illuminated by the NIR light at the points of incidence. A portion of the incident NIR light is absorbed by water within the seed, and a portion of the incident NIR light is scattered from the surfaces of illuminated seeds. In at least one embodiment, the wavelength band of the NIR light ranges substantially between 1200 to 1500 nm, a NIR wavelength range where the reflected intensity has a high inverse correlation with seed moisture content. Thus, the reflected NIR light that reaches the photodetector is substantially the incident light intensity minus the absorbed (by seed moisture) light intensity and scattered light from the seed surface.

The photodetector response may be calibrated by linear regression correlations made between reflected NIR light intensity measured by the photodetector and SMC in seed samples measured independently by conventional techniques, such as gravimetric drying methods. The linear regression correlations are specific to the species of plant, such as grass species, from which the seeds are harvested. As light is reflected from multiple positions within the plane of incidence, measurement of SMC within a seed sample is substantially homogenized. The SMC measurement is instantaneous, enabling an SMC readout to be displayed on the interactive display within seconds. To obtain more randomized measurements, the seed sample within the sample cup may be shaken to redistribute the seeds and a measurement may be re-taken. Multiple SMC measurements may be averaged. Spot sizes of points of incidence may range from 2 to 5 mm, which may cover one or several seeds within each point of incidence.

In a second aspect, a portable seed threshing unit for liberating seeds from seed heads in the field is disclosed. The seeds harvested via the seed threshing apparatus may be analyzed immediately in the field for moisture content in the field with the portable seed moisture content measuring apparatus as described above. The portable seed threshing apparatus can improve both the efficiency of threshing and the effectiveness of adequate sample mixing and uniform subsampling. The sampling machine threshes seeds from heads, mixes threshed seeds thoroughly, and randomly draws seed samples for measuring SMC with the portable device.

In at least one embodiment, the seed threshing unit comprises a threshing unit comprising a rotatable threshing drum, a set of metal beaters that beat on the threshing drum, a vibrating screen assembly, and an air blower. In at least one embodiment, the seed threshing unit comprises electronic circuitry, including a microprocessor and associated logic, a motor drive circuit for controlling a motor coupled to the rotatable threshing drum, a second mechanism for agitating the vibrating screen assembly, and an interactive touchscreen display for user input. In at least one embodiment, the seed threshing unit further comprises an inlet for taking in seed heads. During operation, the rotatable threshing drum drives the beaters to strike the harvested crop material against a concave surface, forcibly removing the seeds from the head without damaging the seeds. The vibrating screen assembly includes multiple layers of sieves, whereby each sieve has a unique opening size. The screen sorts the seeds from larger pieces of chaff, straw, and any other sample contaminants. After screening, only the desired seeds will fall into a mixing chamber below the vibrating screen assembly. During the screening, the air blower sends a stream of air through the falling seeds and chaff, blowing lighter particles of debris away while allowing the heavier seeds to fall directly into the mixing chamber. As seeds from different crop species are of different sizes, there will be choices in screen size so users can select the appropriate size screen for the seed crop they are working with.

In at least one embodiment, the seed threshing unit comprises a paddle mixer disposed in the center of the mixing chamber. The paddle mixer is included in the mixing chamber to gently turn the seeds to mix them without damaging them. In at least one embodiment, the paddle mixer comprises paddles that are made from a pliable material. In at least one embodiment, the paddles extend outward from the surface of a rotating pillar. In at least one embodiment, the paddles are curved and angled to lift and fold the seeds, promoting an even mix. The rotating speed and mixing time are adjustable to ensure thorough mixing. The optimal rotating speed and mixing time for different seed species are programmable in the logic portion of the seed threshing unit.

To ensure uniform sample preparation, a rotary value at the bottom of the mixing chamber allows it to dispense of a controlled volume of seeds, after the completion of mixing. The rotary valve comprises a cylindrical rotor with pockets milled around its perimeter. The pockets are designed to capture a specific volume of seeds as the rotor turns. A stepper motor controls the rotation of the rotor, and the microcontroller decides the number of rotations necessary for different seed species. As the rotor turns, filled pockets align with a discharge chute that guides the seeds into a sample container that prevents light penetration. The moisture content of the seeds in the sample contained can be accurately measured following this process.

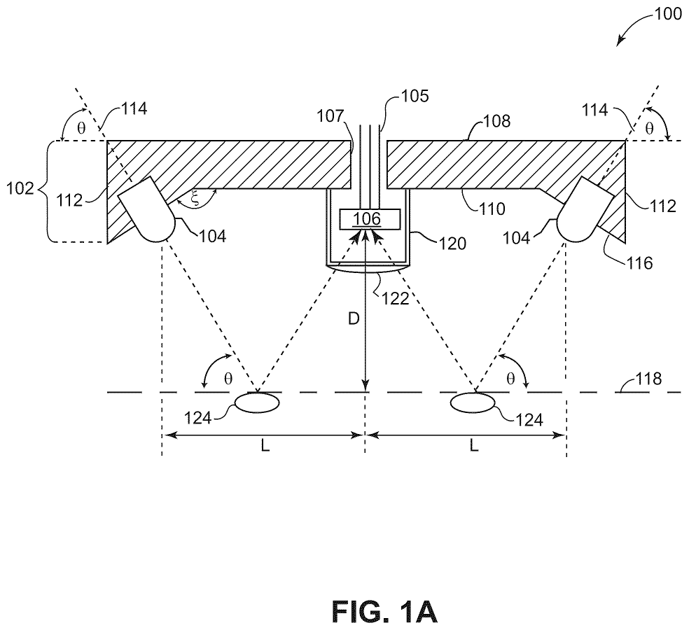

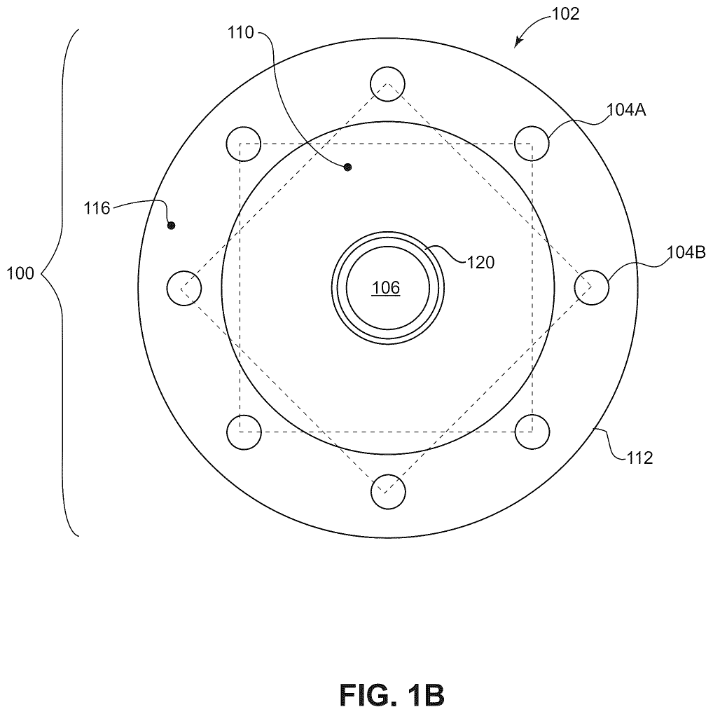

FIG. 1A illustrates a cross-sectional view of a sensor fixture 100, in accordance with at least one embodiment. In at least one embodiment, sensor fixture 100 comprises baseplate 102, LEDs 104, and photodetector 106. In at least one embodiment, baseplate 102 is circular, having an upper surface 108 and opposing lower surface 110. Lower surface 110 is substantially parallel to upper surface 108. In at least one embodiment, sidewall 112 extends around the periphery of baseplate 102. In at least one embodiment, sidewall 112 has a male or female thread (not shown) for attachment to a receptacle within a portable readout console, described below. In at least one embodiment, sidewall 112 comprises a bayonet style attachment feature (not shown), where sidewall 112 has tabs or slots for engaging with a receptacle on the portable readout console, described below.

In at least one embodiment, LEDs 104 is a set of LEDs comprising one or more LEDs disposed near the periphery of baseplate 102. For example, LEDs 104 may be arranged in a circular array having eight individual LEDs 104, disposed equidistantly at the periphery of baseplate 102. Electrical leads 105 may extend from photodetector 106 through aperture 107 through the center of baseplate 102. In at least one embodiment, baseplate 102 can comprise a metallic material such as aluminum, or a rigid polymer plastic material. In at least one embodiment, LEDs 104 have a transparent domed cylindrical package encapsulation, whereby the domed portion protrudes from a bevel 116 on the interior of sidewall 112. Bevel 116 may be inclined at an angle ξ such that a longitudinal axis 114 of any individual LED 104 is tilted at an angle θ with respect to the plane of top surface 108 or bottom surface 110, where ξ=90−θ). Angle ξ of bevel 116 may take on any value, including zero (e.g., zero bevel), without changing the tilt angle θ of LEDs 104 as angle ξ and angle θ are not interdependent. In at least one embodiment, bevel 116 is completely absent (e.g., ξ=180 degrees), and LEDs 104 protrude from lower surface 110 at an angle θ with respect to a horizontal plane (e.g., the plane of surface 110).

Angle θ may be selected to enable emitted light from LEDs 104 to reflect from a plane of incidence 118 and impinge on light photodetector 106. To achieve this, angle θ may be determined by a particular geometry of sensor fixture 100. For example, in the exemplary geometry of sensor fixture 100 shown in FIG. 1A, θ=(π/2−arctan [L/2D]). Thus, θ depends on distances L and D. In at least one embodiment, θ may range between 45 and 70 degrees.

In at least one embodiment, photodetector 106 is a photodiode or a phototransistor. In at least one embodiment, photodetector 106 is housed within a cylindrical package 120. In a further embodiment, package 120 includes an optical window 122, which may be lensed. In at least one embodiment, photodetector 106 is positioned at the center of baseplate 102 to maximize the symmetry of sensor fixture 100, enabling light from all LEDs 104 to reach photodetector 106. Most of the intensity of the emitted light from LEDs 104 may emerge from the center of the domed portion of the LED structure as a beam travelling along paths indicated by the dashed arrows shown in FIG. 1A. Beams of emitted light may diverge by a finite angle, for example, of 20 degrees. In some embodiments, LEDs may be surface mount components. Thus, emitted light impinging on plane of incidence 118, which comprises the surfaces of seeds 124, may be spread by this angular divergence to form spots having average diameters of 2 to 5 mm.

In some embodiments, sensor fixture 100 may comprise four or eight LEDs, thus four or eight sampling points (e.g., points of incidence) are provided to obtain SMC data on any seed sample. As will be described below, in recognition of the variability of moisture content of individual seeds within a plurality of seeds harvested for SMC measurements, seeds in the sample may be randomized to ensure a representative sampling. A portion of the light emitted from LEDs 104 is absorbed by any water existing at the surface of the seeds illuminated by the LED light. The NIR light may penetrate a small distance into the husk and surface tissues of the seeds, sampling bound water content in these tissues within the depth of penetration, as well as surface water. This NIR light may be partially absorbed by the water confined to the husk and tissues immediately below the surface of the husk. Some NIR absorption may be caused by molecules other than water in the tissue structure, such as cellulose, starches, sugars, and proteins. In addition to absorption, light scattering may also occur due to non-specular reflections of the impinging NIR light. Thus, the reflected NIR light intensity reaching photodetector 106 may be the incident light intensity minus absorbed light minus scattered light. As losses due to scattered light may be substantially constant from sample to sample, while losses by light absorption by structural molecules such as cellulose, starches, sugars and proteins in the seed tissues may be minor or non-existent at the measurement wavelengths where water absorbs strongly, the principal variability in the NIR SMC measurements is substantially due to moisture content in any seed sample.

FIG. 1B illustrates a plan view of sensor fixture 100, in accordance with at least one embodiment. The plan view shows an exemplary distribution of LEDs 104, whereby eight LEDs are arranged in a circular array along the periphery of baseplate 102. In at least one embodiment, the circular array of LEDs comprises two sets of four LEDs, referenced as LEDs 104A and LEDs 104B. Each LED set has a different peak wavelength. In the exemplary configuration, LEDs 104A and LEDs 104B are arranged in two interpenetrating square arrays, indicated by the dashed squares rotated by 45 degrees relative to one another. In at least one embodiment, LEDs 104A alternate with LEDs 104B along the circular array, providing a symmetric signal source for photodetector 106. An eight-element circular array of LEDs is configured to provide eight sample points on the plane of incidence within a sample cup, described below. While eight LEDs are shown in the illustrative embodiment, for greater sensitivity, more LEDs may be included within the circular array of LEDs. It is understood that the number of LEDs is not limited to eight as shown, but any suitable number of LEDs may be included in sensor fixture 100.

As noted above, LED spectral characteristics are generally narrow-banded (e.g., bandwidth <150 nm). In at least one embodiment, the 1200 nm 1500 nm measurement bandwidth of reflected NIR light deemed most sensitive to changes in SMC may be covered by incorporation of two or more LED groups into the LED array. In at least one embodiment, each group, LEDs 104A and 104B, has overlapping spectral output. For example, the peak wavelengths of each LED group may be 1300 nm and 1450 nm, respectively. Thus, peak wavelengths may be separated by 100 to 200 nm of one another to allow sufficient overlap of spectral bandwidth. Spectra from LEDs may typically have gaussian or similar highly peaked distributions about the peak wavelength. The spectral overlap between LEDs 104A and LEDs 104B can provide continuous spectral coverage within the specified broad NIR wavelength range (e.g., 1200 nm-1500 nm) that exhibits a high sensitivity to changes in SMC.

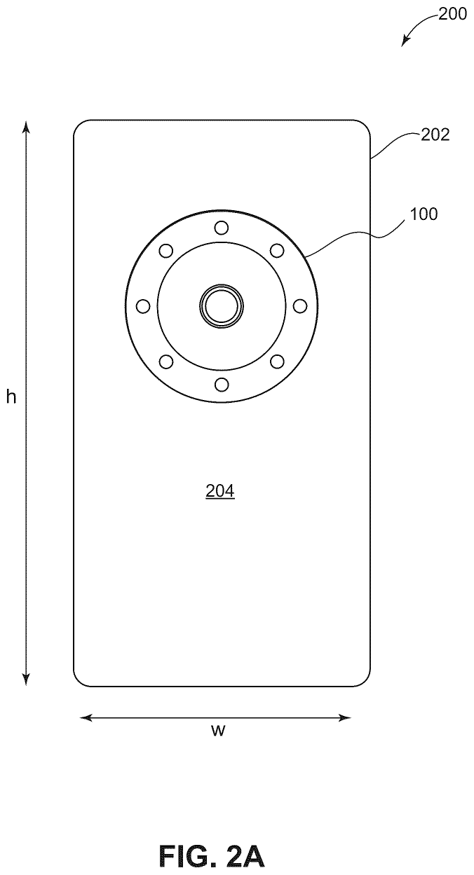

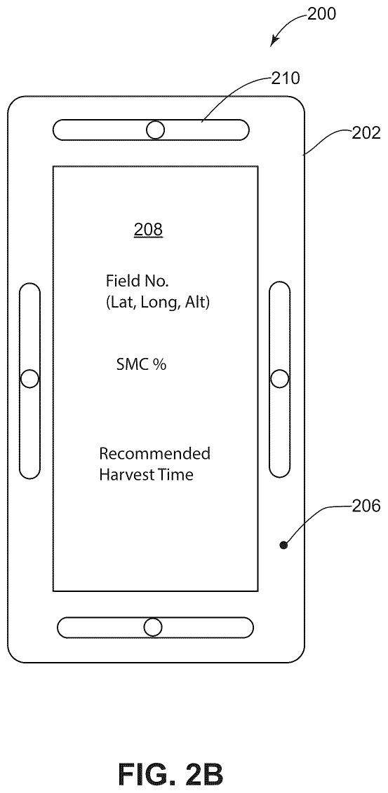

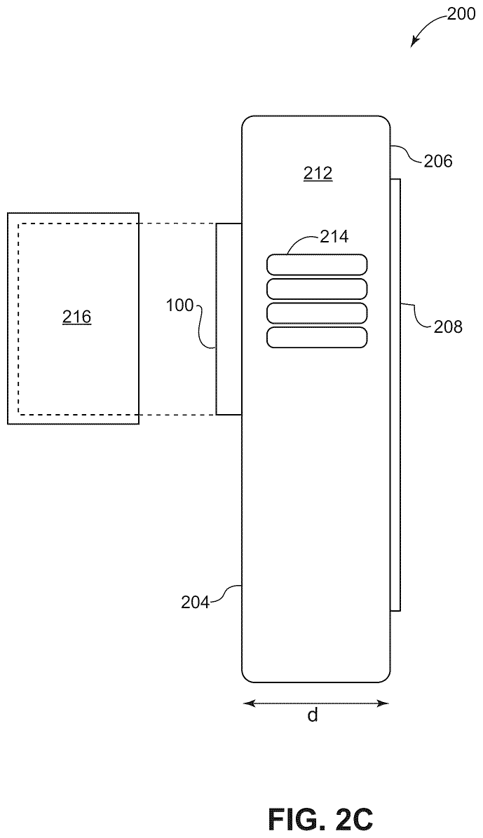

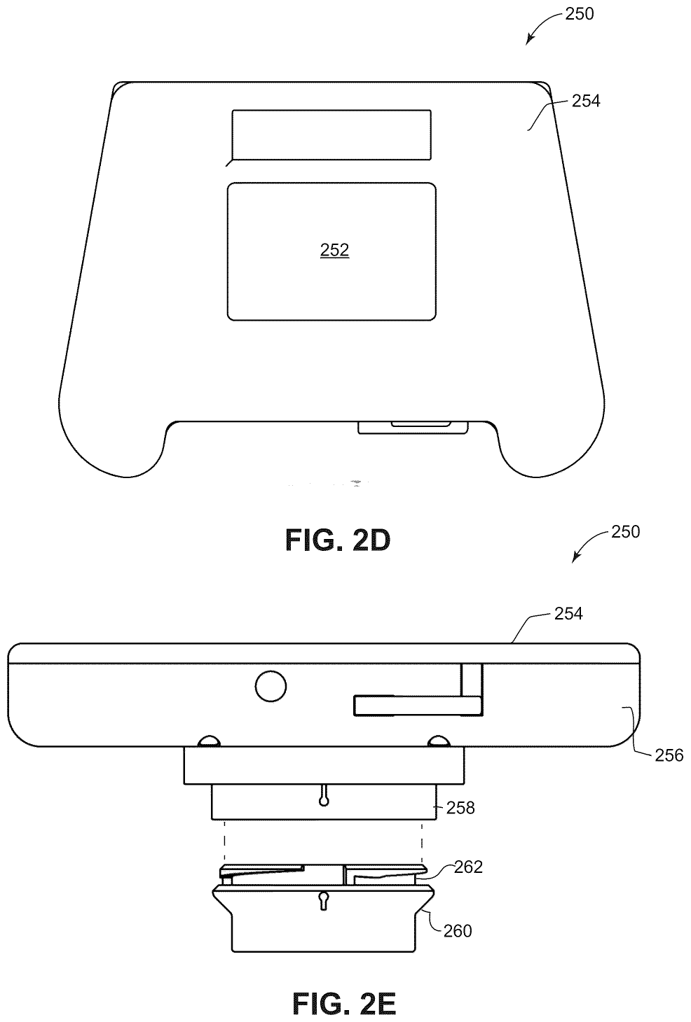

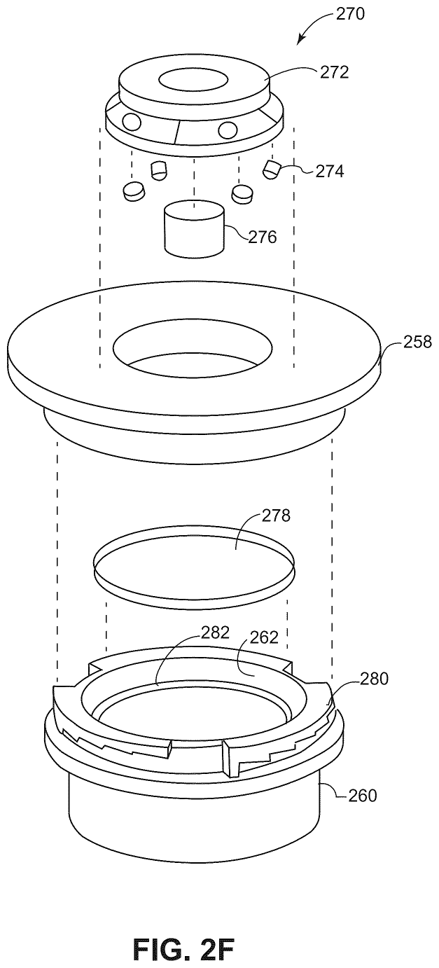

FIG. 2A illustrates a plan view of a rear panel of portable SMC readout console 200, in accordance with at least one embodiment. In at least one embodiment, SMC readout console 200 comprises enclosure 202. In at least one embodiment, enclosure 202 has a rectangular form factor, having a hollow body with six sides and an overall length h and width w. In at least one embodiment, h may range between 6 and 8 inches (15 cm to 20 cm), and w may range between 3 and 5 inches (7.5 cm to 12.5 cm). In the view of the figure, rear panel 204 is shown, comprising sensor fixture 100 incorporated into rear panel 204. In at least one embodiment, sidewall 112 of sensor fixture 100 protrudes above rear panel 204 for attachment of a sample cup, as described below.

In at least one embodiment, sensor fixture 100 may be affixed to a printed circuit board (PCB) within enclosure 202 by surface mount techniques, for example, and protrude outwardly through an opening in rear panel 204 for attachment of a sample cup. In at least one embodiment, sensor fixture 100 may be rigidly integral with rear panel 204, where baseplate 102 is formed integrally with rear panel 204 during manufacture of enclosure 202. In at least one embodiment, sensor fixture 100 is removable, whereby sensor fixture 100 locks into a receiving portion of rear panel 204. For example, sensor fixture 100 may be attached and detached by a partial rotation of a threaded portion (not shown) or by a bayonet style mechanism similar to that described above. A PCB (not shown) may be mounted on upper surface 108, for example, for providing rigid electrical connection to LEDs 104 and photodetector 106. A cable, such as a ribbon cable, may be connected to the removable PCB attached to sensor fixture 100 and to a fixed PCB within enclosure 202 to couple LEDs 104 and photodetector 106 to driver circuitry on the fixed PCB, as described below.

FIG. 2B illustrates a plan view of a front panel 204 of portable SMC readout console 200, in accordance with at least one embodiment. In at least one embodiment, front panel 204 comprises display screen 208. In at least one embodiment, display screen 208 is a touchscreen for interactive operation of portable SMC readout console 200. In at least one embodiment, front panel 204 comprises bubble level indicators 210. In at least one embodiment, bubble level indicators 210 may aid in maintaining a level surface of seeds at a plane of incidence within the sample cup.

FIG. 2C illustrates a view of a side panel 212 of portable SMC readout console 200, in accordance with at least one embodiment. In at least one embodiment, side panel 212 has a width d, where d may range between 1 inch and 1.5 inches (2.5 to 3 cm). In at least one embodiment, side panel 212 comprises finger grips 214 for ease of handling. In at least one embodiment, sample cup 216 is shown detached from sensor fixture 100. Dashed lines indicate points of attachment of sample cup 216. Bottom 218 of sample cup 216 faces away from rear panel 204.

In at least one embodiment, sample cup 216 may be partially filled with a seed sample and attached to sensor fixture 100, where the seed cup 216 is filled to top of the seed cup to indicate a plane of incidence for maximal collection of reflected NIR light by the photodetector in sensor fixture 100. Seed cup 216 may then be attached to sensor fixture 100. Once the seed cup is attached, a piece of glass will press the seed surface and make sure there is a consistent distance between seed surface and the sensor. In at least one embodiment, portable SMC readout console 200 is held by the user such that rear panel 204 is facing downward. In this position, display screen 208 is facing upward toward the user and seed cup 216 is oriented such that the seed sample is retained in the lower portion of seed cup 216, bottom 218 facing downward. Portable SMC readout console 200 may be held substantially horizontally by a user to level the seed sample in the plane of incidence. The user may be guided by bubble level indicators 210 to maintain horizontal alignment with the local gravity field. A SMC reading may be initiated by the user interacting with display screen 208.

FIG. 2D illustrates a top plan view of a SMC readout console 250, having a gaming console configuration or gaming-style interaction with a user. SMC readout console 250 comprises a display screen 252 mounted within top plate 254. Display screen 252 may be a touch screen, having functions substantially the same as described above for display screen 208.

FIG. 2E illustrates a profile view of SMC readout console 250 with seed cup 260 detached. Top plate 254 is attached to enclosure body 256, which houses a PCB (not shown), similar or substantially identical to that described for SMC readout console 200. Enclosure body 256 and other parts may comprise a suitable polymer material of construction. In some embodiments, some parts described below are integral with enclosure body 256, and may be formed by a molding process. In at least one embodiment, the PCB may be coupled to a sensor fixture similar or substantially identical sensor fixture 100. In at least one embodiment, enclosure body 256 comprises a coupling port 258 for attachment of seed cup 260 to enclosure body 256. As will be shown in FIG. 2F, seed cup 260 may have a style an attachment collar 262 that may be threaded or bayonet style for ease of attachment of seed cup 260 to enclosure body 256. The sensor fixture may be positioned within coupling port 258. In at least one embodiment, seed cup 260 is positioned directly below the sensor fixture when attached to coupling port 258.

FIG. 2F illustrates a 3D exploded view of coupling port assembly 270, showing sensor fixture 272, LEDs 274, photodetector 276, coupling port 258, optical flat 278 and seed cup 260. In at least one embodiment, sensor fixture 272 may be substantially the same as sensor fixture 100, shown in FIGS. 1A and 1B. Photodetector 276 seats in the center of sensor fixture 272. In at least one embodiment, photodetector 276 may be substantially the same as photodetector 106 shown in FIGS. 1A and 1B. A plurality of LEDs 274 may be configured around photodetector 276, substantially as shown in FIG. 1B in regard to LEDs 104 seated within baseplate 102, surrounding photodetector 106 at the center of baseplate 102 of sensor fixture 100. Here, LEDs 274 may be seated within mounting holes in the body of sensor fixture 272, similar to baseplate 102. As noted, photodetector 276 is at the center of sensor fixture 272. The size of sensor fixture 272 may be adjusted for optimal reflection angles of light impinging on seeds within seed cup 260 and reflected to photodetector 276.

Coupling port 258 may be integral with a bottom surface of enclosure body 256 as noted above. Sensor fixture 272 may be substantially within enclosure body 256. Sensor fixture 272 may extend at least partially within coupling port 258. In at least one embodiment, the interior wall (not shown) of coupling port 258 may be threaded or have slots configured to mesh with threads (not shown) or bayonet prongs on seed cup 260, such as bayonet prongs 280 shown in FIGS. 2E and 2F, on attachment collar 262 of coupling port 258.

In at least one embodiment, the optical flat 278 is an optically transparent window that may be positioned between seed cup and sensor fixture 272 after addition of seeds. Optical flat 278 may be manually seated on ledge 282 prior to attaching seed cup 260 to coupling port 258. Optical flat 278 provides a transparent barrier to seal off the atmosphere within seed cup 260, retaining initial moisture levels of the seeds for accurate moisture measurements. Transparent quality of optical flat 278 enables passage of transmitted and reflected light form LEDs 274. Optical flat 278 may also prevent seeds from being inadvertently moved close to sensor fixture 272. Optical flat 278 may comprise quartz or fused silica for ultraviolet transparency.

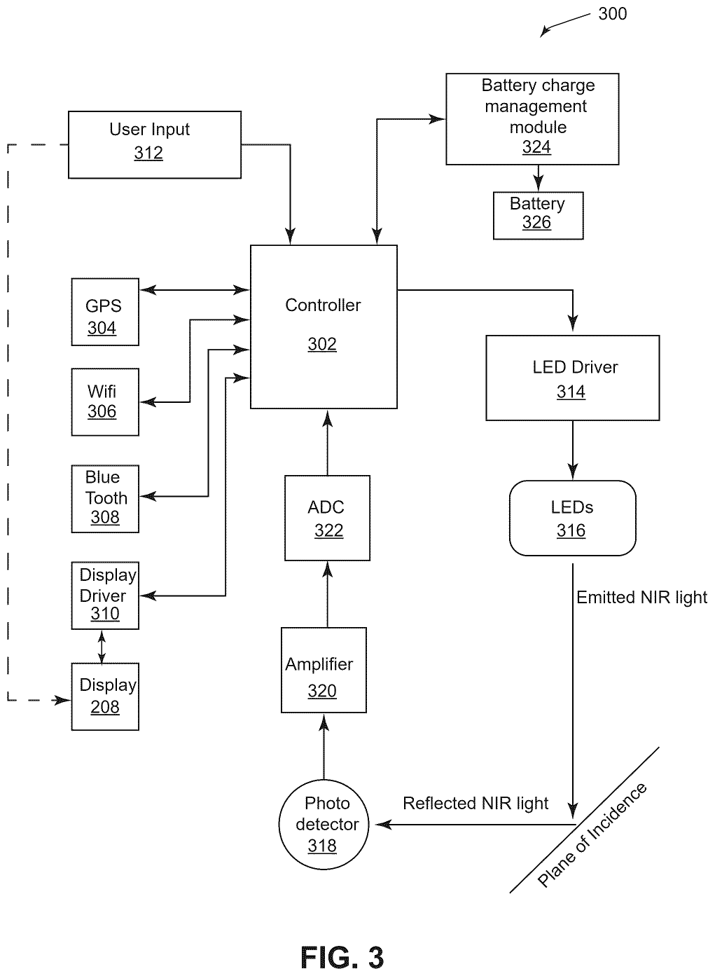

FIG. 3 illustrates a block diagram 300 of an electronic control circuitry for portable SMC readout console 200, in accordance with at least one embodiment. Central to the control circuitry is processor 302. In at least one embodiment, processor 302 is a microprocessor or microcontroller unit, such as an Arduino series microprocessor. In at least one embodiment, the electronic control circuitry includes a GPS module 304 for providing exact geolocation coordinates of a seed sampling and/or harvesting position. GPS module 304 is in electronic communication with processor 302.

In at least one embodiment, the control circuitry comprises a wifi controller module 306 and a Bluetooth controller module 308 for wireless data linking. The control circuitry further includes a display driver 310 that manages display screen 208. In at least one embodiment, display screen 208 is an interactive touchscreen, thus data moves in two directions from display screen 208. In at least one embodiment, processor 302 accepts user inputs 312. In at least one embodiment, user inputs 312 are routed through display screen 208. For example, a user may select a particular seed species to identify a sample by grass species, for example. A readout of SMC data is displayed on display screen 208 once a measurement is taken for the user. NIR reflectance measurement data calibrations for reporting SMC data are substantially specific to seed species. In at least one embodiment, calibration curves for different grass species are stored in a memory (not shown) coupled to processor 302. In at least one embodiment, all above-described modules may be incorporated as integrated circuits (ICs) that are mounted on one or more PCBs housed within enclosure 202.

In at least one embodiment, processor 302 commands an LED driver module 314, which drives a plurality of LEDs 316, such as LEDs 104 (including LEDs 104A and 104B) shown in FIGS. 1A and 1B. For example, processor 302 may simply turn LEDs 316 on and off. Processor 302 may also adjust LED intensity. Reflected light from LEDs 316 is received by photodetector 318. In at least one embodiment, photodetector 318 is the same as photodetector 106 shown in FIGS. 1A and 1B and may be a photodiode or phototransistor. In at least one embodiment, photodetector 318 is coupled to an amplifier circuit 320, which may include an operational amplifier IC mounted on a PCB. In at least one embodiment, the output of amplifier circuit 320 is digitized by analog to digital converter (ADC) 322 and fed to processor 302 to generate the SMC measurement and readout.

In at least one embodiment, the control circuit may optionally include a battery charge management module 324. The charge on a battery 326 may be monitored by battery charge management module 324 to inform the user of the battery status.

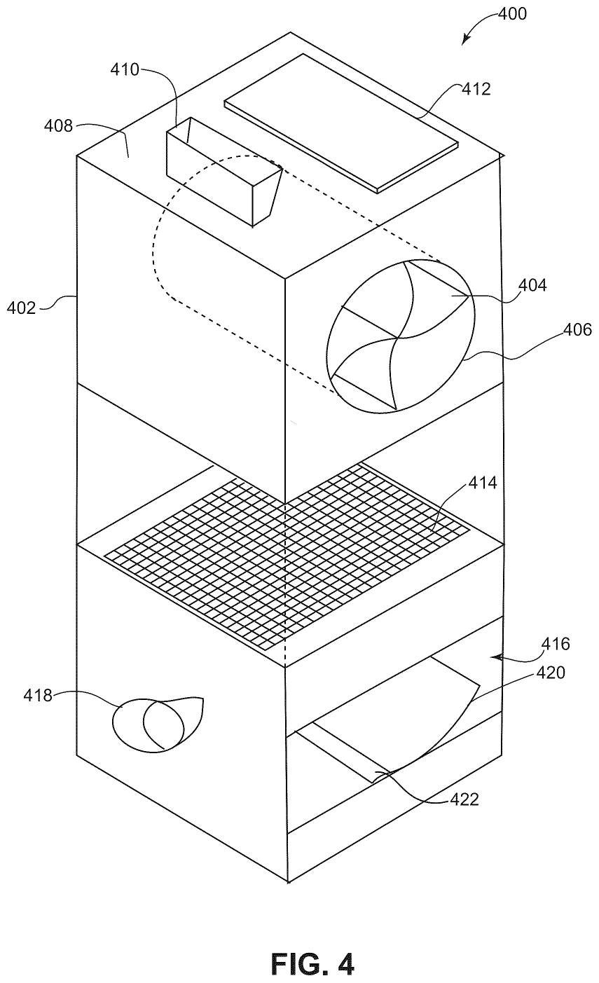

FIG. 4 illustrates an isometric view of a portable seed threshing apparatus 400, in accordance with at least one embodiment. In at least one embodiment, portable seed threshing apparatus 400 comprises a housing 402. Within an upper portion of housing 402, portable seed threshing apparatus 400 comprises a rotatable threshing drum 404, whereby the rotatable threshing drum 404 comprises beaters 406. On an upper surface 408, portable seed threshing apparatus 400 comprises a seed inlet 410 and a display screen 412. In at least one embodiment, display screen 412 is an interactive touch screen for user input.

Rotatable threshing drum 404 removes seeds from the seed head. Curved beaters 406 perform the separation without damaging the seeds. A cutaway view of the interior of housing 402 shows a vibrating screen 414 below rotatable threshing drum 404. In at least one embodiment, vibrating screen 414 comprises a plurality of screens having progressively smaller mesh sizes. The combination of screens performs a sorting function, whereby seeds are separated from chaff, straw and other debris. Seeds fall through vibrating screen 414 to a mixing chamber 416 in a lower portion of housing 402. Screen meshes may be chosen to conform to different seed sizes. In at least one embodiment, an air blower 418 sends a stream of air through the falling seeds and chaff, blowing lighter particles of debris away while allowing the heavier seeds to fall directly into mixing chamber 416.

In at least one embodiment a paddle mixer 420 is within mixing chamber 416. In at least one embodiment, paddle mixer 420 comprises two or more paddles extending from a rotatable shaft 422. In at least one embodiment, paddles of paddle mixer 420 are curved and made from a compliant material, such as a soft plastic. The shape of the paddles of paddle mixer 420 may be optimized to gently lift and fold the seeds to promote an even mix. Rotatable shaft is coupled to a motor (not shown) that is configured to run at variable speeds. A motor controller may be driven by a motor controller that is programmable to obtain optimal speeds for different sized seeds and species of seed.

In at least one embodiment, to ensure uniform sample preparation, a rotary valve (not shown) is disposed at the bottom of mixing chamber 416. In at least one embodiment, the rotary valve comprises a cylindrical rotor having pockets around its perimeter. The pockets capture a predetermined volume of seeds as the rotor turns. The rotor may be coupled to a motor, such as a stepper motor, that can provide precise control of rotation to ensure accurate volume sampling. For example, motor speeds may be chosen through user input via display screen 412. In at least one embodiment, the pockets align with a discharge chute that guides the seeds into a sample container, such as seed cup 216 shown in FIG. 2B.

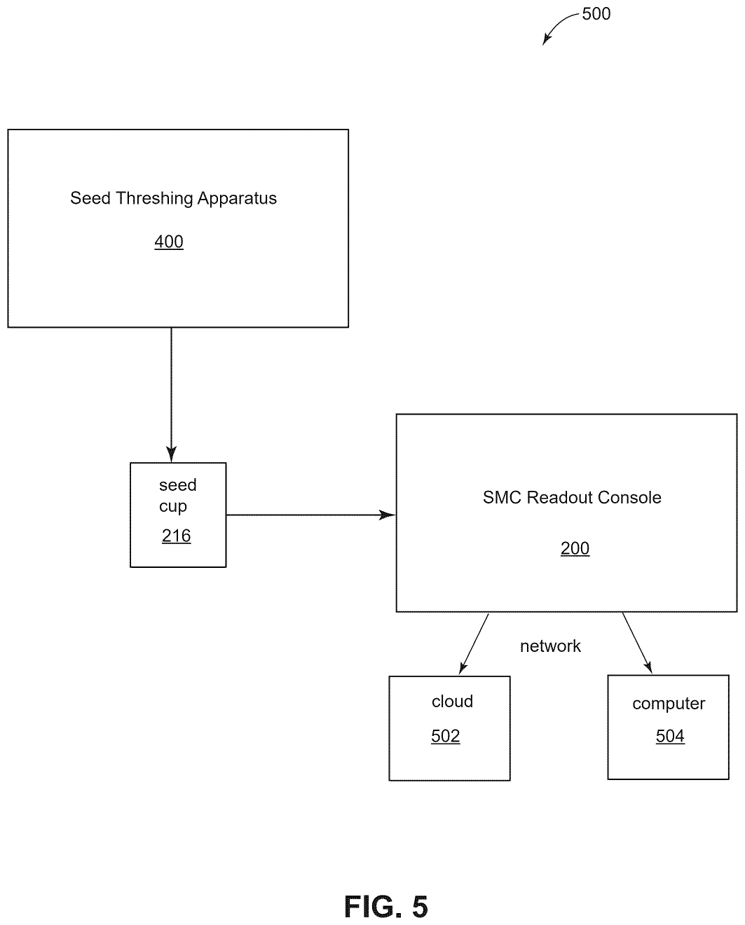

FIG. 5 illustrates a block diagram of a portable SMC measurement system 500 (hereinafter, “system 500”) comprising portable SMC readout console 200 and portable seed threshing apparatus 400, in accordance with at least one embodiment. In at least one embodiment, both portable seed threshing apparatus 400 and portable SMC readout console 200 are used in conjunction with one another. Seed threshing apparatus 400 provides the seed sample, whereby SMC readout console 200 performs the SMC measurement and reports the result. In at least one embodiment, SMC readout console 200 is connected to a cloud server 502 or to a local computing device 504.

In at least one embodiment, system 500 deploys a software application that can be installed on any mobile device (such as phones and tablets) with Bluetooth module 308 within SMC readout console 200, for example. The software allows users to receive data from the portable device and visualize SMC measurements and other geological information related to their fields, on their own mobile devices. Functionalities of the software include establishing a Bluetooth connection between the portable device and mobile devices (phones and tablets with either IOS or Android operating system), receiving the SMC measurements and their geolocations (e.g., from GPS module 304), data processing for creating detailed spatial visualizations of seed moisture, and retrieving a field elevation map and soil type map when Internet service is available. The software is maintained using a local server with a centralized database that stores historical and real-time data, enabling secure data retrieval and analysis. A user-friendly interface is designed to visualize field maps and other relevant information. There are other features allowing users to manually input or update other aspects of their field and crop details as desired.

In at least one embodiment, system 500 is configured to predict harvest timing for individual seed production fields, based on their current SMC and the predicted weather forecast. The prediction function is hosted in a software application, such as noted above. In at least one embodiment, the prediction model is trainable using historical seed moisture data, harvest timings, soil types, and corresponding weather conditions to identify patterns and make accurate predictions. In at least one embodiment, once geo-referenced moisture measurements are downloaded from SMC portable readout console 200, the application may retrieve real-time and forecasted weather data from external weather service APIs when Internet service is available. These data may include temperature, humidity, precipitation, and wind speed. The optimal harvest time can then be calculated using the trained model with the SMC measurements and weather forecasts as inputs. An alert function in the application will notify users about the recommended harvest times. Notifications can be configured to be sent via SMS, email, or directly through the software application. The application will update weather data at regular intervals (e.g., hourly) and adjust the predicted harvest time based on the updated weather conditions. A feedback function in the application will be developed to incorporate user feedback on actual harvest results to fine-tune the predictive models. This feedback mechanism helps in continuously improving the accuracy of the predictions.

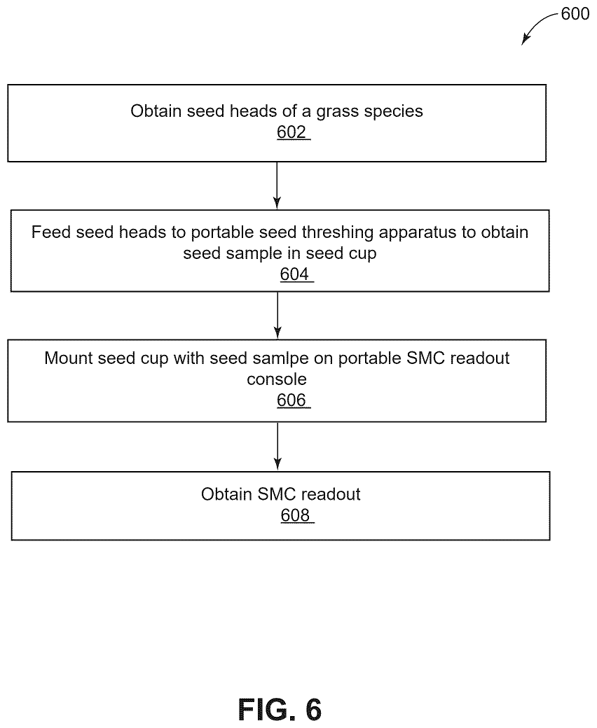

FIG. 6 illustrates a flowchart 600 summarizing an exemplary method for measuring SMC of seed samples using system 500, in accordance with at least one embodiment. It is understood that the method described in flowchart 600 is one embodiment. Variations of the method described below may be made without deviating from the scope of this disclosure.

At operation 602, an operator is deployed into a field where a particular species of grass is grown. The operator may drive into the field in a motor vehicle such as a pickup truck or car, taking along portable seed threshing apparatus 400 and portable SMC readout console 200. The operator collects seed heads of a particular species of grass. For example, to determine the SMC of a particular seed production field, a minimum sample of 30 to 50 seed heads are randomly collected from representative areas of the field. Although seeds may then be stripped from the heads by hand, this operation is not necessary as portable seed threshing apparatus 400 is configured to perform this operation.

At operation 604, freshly picked seed heads are fed to the portable seed threshing apparatus 400. As described above, portable seed threshing apparatus 400 gently removes seeds from seed heads and collects seeds in sample cup 216. Seeds are substantially free of chaff and other debris. Sample cup 216 is filled to a depth that coincides with a plane of incidence to reflect light from the LEDs of sensor fixture 100 within portable SMC readout console 200.

At operation 606, the operator removes seed cup 216 from the portable seed threshing apparatus 400 and mount it over the sensor fixture 100 on portable SMC readout console 200. Seed cup 216 may be attached by engaging threaded portions or by a bayonet attachment system.

At operation 608, the operator triggers a SMC measurement via display screen 208 on portable SMC readout console 200. The measurement may take up to several seconds. Multiple measurements may be conducted in succession and averaged in accordance with programming of operation software managing SMC readout console 200. The SMC result (e.g., as percent SMC) is then displayed on display screen 208. In at least one embodiment, harvest timing data may also be displayed in addition to the SMC result. In at least one embodiment, the SMC result is accompanied by a harvest timing prediction based on the SMC result.

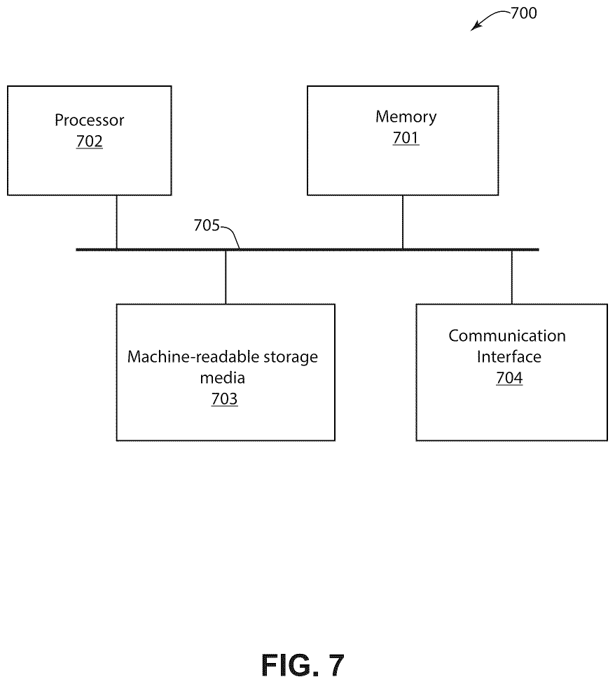

FIG. 7 illustrates a processor system 700 with a machine-readable storage medium having machine-readable instructions that when executed cause a circuit board of a control unit of portable SMC readout console 200 to execute machine-readable instructions according to the method summarized by flowchart 600, in accordance with at least one embodiment. In at least one embodiment, processor system 700 comprises memory 701, processor 702, machine-readable storage medium 703 (also referred to as tangible machine-readable medium), communication interface 704 (e.g., wireless or wired interface), and network bus 705 coupled together as shown. In at least one embodiment, processor system 700 may be part of a computing system associated with SMC readout console 200. In at least one embodiment, processes described herein may be stored in machine readable medium 703 as computer-executable instructions. In at least one embodiment, a machine-readable storage medium may be random access memory (RAM).

In at least one embodiment, processor 702 is a digital signal processor (DSP), an application specific integrated circuit (ASIC), a general-purpose central processing unit (CPU), or a low power logic implementing a simple finite state machine to perform various processes described herein. In at least one embodiment, processor 702 is equivalent to processor 302 shown in FIG. 3.

In at least one embodiment, various logic blocks of processor system 700 are coupled together via network bus 705. Any suitable protocol may be used to implement network bus 705. In at least one embodiment, machine-readable storage medium 703 includes instructions (also referred to as program software code/instructions) for actuating valves of the process gas delivery system, and heating portions of delivery lines, for example, coded into software stored in machine-readable storage medium 703.

In at least one embodiment, machine-readable storage media 703 is a machine-readable storage media with instructions for operation of SMC readout console 200. In at least one embodiment, machine-readable medium 703 has machine-readable instructions, that when executed, cause processor 702 to perform the method discussed herein

In at least one embodiment, program software code/instructions associated with various embodiments may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, program software code/instructions associated with processes of various embodiments are executed by processor system 700.

In at least one embodiment, machine-readable storage media 703 is a computer executable storage medium. In at least one embodiment, program software code/instructions associated with various embodiments are stored in computer executable storage medium 703 and executed by processor 702. Here, computer executable storage medium 703 is a tangible machine-readable medium 703 that can be used to store program software code/instructions and data that, when executed by a computing device, causes one or more processors (e.g., processor 702) to perform a process.

In at least one embodiment, tangible machine-readable medium 703 may include storage of executable software program code/instructions and data in various tangible locations, including for example, ROM, volatile RAM, non-volatile memory, and/or cache, and/or other tangible memory as referenced in present application. Portions of this program software code/instructions and/or data may be stored in any one of these storage and memory devices. In some embodiments, program software code/instructions can be obtained from other storage, including, e.g., through centralized servers or peer to peer networks and the like, including the Internet. Different portions of software program code/instructions and data can be obtained at different times and in different communication sessions or in the same communication session.

In at least one embodiment, software program code/instructions associated with various embodiments can be obtained in their entirety prior to execution of a respective software program or application. Alternatively, portions of software program code/instructions and data can be obtained dynamically, e.g., just in time, when needed for execution. Alternatively, some combination of these ways of obtaining software program code/instructions and data may occur, e.g., for different applications, components, programs, objects, modules, routines, or other sequences of instructions or organization of sequences of instructions, by way of example. Thus, it is not required that data and instructions be on a tangible machine-readable medium 703 in entirety at a particular instance of time.

In at least one embodiment, tangible machine-readable medium 703 include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMs), Digital Versatile Disks (DVDs), etc.), among others. In at least one embodiment, software program code/instructions may be temporarily stored in digital tangible communication links while implementing electrical, optical, acoustical, or other forms of propagating signals, such as carrier waves, infrared signals, digital signals, etc. through such tangible communication links.

In some instances, well-known methods and devices are shown in block diagram form, rather than in detail, to avoid obscuring at least one embodiment. Reference throughout this specification to “an embodiment,” “one embodiment,” “in at least one embodiment,” or “some embodiments” means that a particular feature, structure, function, or characteristic described in connection with embodiment is included in at least one embodiment. Thus, appearances of phrase “in an embodiment,” “in at least one embodiment,” or “in one embodiment” or “some embodiments” in various places throughout this specification are not necessarily referring to same embodiment of disclosure. Furthermore, particular features, structures, functions, or characteristics may be combined in any suitable manner in one or more embodiments. For example, a first embodiment may be combined with a second embodiment anywhere particular features, structures, functions, or characteristics associated with two embodiments are not mutually exclusive.

In the following paragraphs, examples are provided that illustrate various embodiments. Here, examples can be combined with other examples. As such, various embodiments can be combined with other embodiments without changing scope of disclosure.

Example 1 is sensor fixture, comprising a base plate having a first surface and an opposing second surface; one or more light emitting diodes (LEDs) are oriented obliquely between the first surface and the second surface, wherein ones of the one or more LEDs are configured to emit a beam of infrared light extending from the second surface; and a photodetector disposed at a center of the base plate.

Example 2 is a sensor fixture as in any of the examples, particularly example 1, wherein the ones of the one or more LEDs are oriented at an angle ranging between 45 and 70 degrees with respect to the second surface such that the beam of an infrared light impinges on a plane of incidence and is reflected from the plane of incidence to the photodetector.

Example 3 is a sensor fixture as in any of the examples, particularly example 2, wherein the base plate is circular, and wherein the one or more LEDs are disposed in a circular array along a periphery of the base plate.

Example 4 is a sensor fixture as in any of the examples, particularly example 2, wherein the base plate has a sidewall extending from the first surface to below the second surface, and wherein a bevel extends between the sidewall and a portion of the second surface.

Example 5 is a sensor fixture as in any of the examples, particularly example 4, wherein the sidewall comprises a threaded portion; a first slot configured to engage a tab; or a tab configured to engage a second slot.

Example 6 is a sensor fixture as in any of the examples, particularly example 4, wherein the one or more LEDs are within the bevel.

Example 7 is a sensor fixture as in any of the examples, particularly example 5, wherein the angle is a first angle, and wherein the bevel has a second angle with respect to the second surface that is related to the first angle.

Example 8 is a sensor fixture as in any of the examples, particularly example 1, wherein the photodetector is a photodiode or a phototransistor.

Example 9 is a sensor fixture as in any of the examples, particularly example 1, wherein one or more the LEDs comprise a first set of LEDs and a second set of LEDs, wherein individual LEDs of the first set of LEDs have a first spectral output, wherein individual LEDs of the second set of LEDs have a second spectral output and wherein the first spectral output is combined with the second spectral output to cover a spectrum ranging between at least 1200 nm to 1500 nm

Example 10 is a seed moisture content (SMC) measuring apparatus, comprising an enclosure having a rectangular form factor, wherein the enclosure has a first panel and an opposing second panel; a sensor fixture disposed on the first panel, wherein the sensor fixture comprises: a base plate having a first surface and an opposing second surface; one or more light emitting diodes (LEDs) are oriented obliquely between the first surface and the second surface, wherein ones of the one or more LEDs are configured to emit a beam of infrared light extending from the second surface; and a photodetector disposed at a center of the base plate; a display screen disposed on the second panel; and one or more bubble level indicators disposed on the second panel.

Example 11 is an apparatus as in any of the examples, particularly example 10, further comprising an electronic control circuit within the enclosure, wherein the electronic control circuit comprises a processor, wherein the processor is coupled to a wifi module, a Bluetooth module, and a display driver, wherein the display screen is a touchscreen coupled to the display driver.

Example 12 is an apparatus as in any of the examples, particularly example 11, wherein the processor is coupled to a LED driver and to the photodetector, wherein the photodetector is configured to receive reflected light from the one or more LEDs in the sensor fixture, and wherein the processor reads an output of the photodetector when the photodetector receives the reflected light from the one or more LEDs and converts the output of the photodetector to a seed moisture content (SMC).

Example 13 is a system comprising a seed moisture content (SMC) measuring apparatus, wherein the SMC measuring apparatus comprises: an enclosure having a gaming console form factor, wherein the enclosure has a first panel and an opposing second panel; a sensor fixture disposed on the first panel, wherein the sensor fixture comprises: a base plate having a first surface and an opposing second surface; one or more light emitting diodes (LEDs) are oriented obliquely between the first surface and the second surface, wherein ones of the one or more LEDs are configured to emit a beam of infrared light extending from the second surface; and a photodetector disposed at a center of the base plate; a display screen disposed on the second panel; and one or more bubble level indicators disposed on the second panel; and a seed threshing apparatus, comprising a housing; a threshing drum disposed within the housing; a vibrating screen disposed within the housing below the threshing drum; a mixing chamber disposed within the housing below the vibrating screen; a mixing paddle disposed within the housing below the vibrating screen; and a rotary valve disposed within the housing below the mixing paddle.

Example 14 is a system as in any of the examples, particularly example 13, wherein the seed threshing apparatus further comprises a seed sample cup below the rotary valve and configured to attach to the sensor fixture.

Example 15 is a system as in any of the examples, particularly example 13, wherein the display screen is a first display screen, and wherein the seed threshing apparatus further comprises a second display screen disposed on the housing.

Example 16 is a system as in any of the examples, particularly example 13, wherein the vibrating screen comprises a plurality of screens in a stack, wherein individual screens of the plurality of screens have different mesh sizes.

Example 17 is a method comprising obtaining a plurality of seed heads from a grass species; feeding the plurality of seed heads to a portable seed threshing apparatus, wherein the housing; a vibrating screen disposed within the housing below the threshing drum; a mixing chamber disposed within the housing below the vibrating screen; a mixing paddle disposed within the housing below the vibrating screen; a rotary valve disposed within the housing below the mixing paddle; and a seed sample cup below the rotary valve; and filling the seed sample cup with seeds to a predetermined depth.

Example 18 is a method as in any of the examples, particularly example 17, further comprising: attaching the seed sample cup to a portable seed moisture content (SMC) readout console, wherein the SMC readout console comprises: an enclosure having a rectangular form factor, wherein the enclosure has a first panel and an opposing second panel; and a sensor fixture disposed on the first panel, wherein the sensor fixture comprises: a base plate having a first surface and an opposing second surface; one or more light emitting diodes (LEDs) are oriented obliquely between the first surface and the second surface, wherein ones of the one or more LEDs are configured to emit a beam of infrared light extending from the second surface; and a photodetector disposed at a center of the base plate; a display screen disposed on the second panel; and one or more bubble level indicators disposed on the second panel.

Example 19 is a method as in any of the examples, particularly example 18, further comprising initiating a SMC reading, wherein a user input is given to the display screen of the SMC readout console.

Example 20 is a method as in any of the examples, particularly example 19, wherein the SMC reading is accompanied by a harvest timing reading, and wherein the SMC reading and the harvest timing reading are read wirelessly by a local computing device or by a cloud computing device.

Example 1a is an apparatus for measuring seed moisture content (SMC), comprising: an enclosure; a seed cup attachable to an attachment ring extending from an opening within a first panel of the enclosure; a display screen within a second panel of the enclosure, wherein the second panel opposes the first panel; and a sensor fixture within the enclosure, wherein the sensor fixture is oriented over the seed cup from within the enclosure, and wherein the sensor fixture comprises: a baseplate; a photodetector disposed at a center of the baseplate; and one or more light emitting diodes (LEDs) disposed around a periphery of the baseplate, wherein the one or more LEDs are oriented toward the seed cup.

Example 2a is an apparatus as in any of the examples, particularly example 1a, further comprising an electronic control circuit within the enclosure, wherein the electronic control circuit is coupled to the display screen and to the one or more LEDs.

Example 3a is an apparatus as in any of the examples, particularly example 2a, wherein the electronic control circuit comprises a processor, wherein the processor is coupled to a wifi module, a Bluetooth module, and a display driver.

Example 4a is an apparatus as in any of the examples, particularly example 3a, wherein the display driver is coupled to the display screen.

Example 5a is an apparatus as in any of the examples, particularly example 1a, wherein the display screen is a touch screen.

Example 6a is an apparatus as in any of the examples, particularly example 3a, wherein the processor is coupled to a LED driver and to the photodetector, wherein the photodetector is configured to receive a light signal reflected from a plurality of seeds within the seed cup, wherein the light signal is emitted from the one or more LEDs in the sensor fixture, and wherein the processor reads an output of the photodetector when the photodetector receives the reflected light from the one or more LEDs and converts the output of the photodetector to a seed moisture content.

Example 7a is an apparatus as in any of the examples, particularly example 1a, wherein the one or more LEDs are oriented at an angle ranging between 45 and 70 degrees with respect to the baseplate.

Example 8a is an apparatus as in any of the examples, particularly example 1a, wherein seed cup comprises a rim, wherein the rim comprises one or more tabs, wherein the one or more tabs are configured to engage within one or more slots oriented around an opening in the first panel for attachment of the seed cup to the enclosure.

Example 9a is an apparatus as in any of the examples, particularly example 1a,, wherein the enclosure has a gaming console geometry, wherein the first panel and the second panel have a substantially trapezoidal geometry, wherein the first panel and the second panel each have a first lobe extending from first corner and a second lobe extending from a second corner, and wherein the first corner and the second corner are adjacent to one another.

Example 10a is an apparatus as in any of the examples, particularly example 1a, wherein one or more the LEDs comprise a first set of LEDs and a second set of LEDs, wherein individual LEDs of the first set of LEDs have a first spectral output, wherein individual LEDs of the second set of LEDs have a second spectral output and wherein the first spectral output is combined with the second spectral output to cover a spectrum ranging between at least 1200 nm to 1500 nm.

Example 11a is system a seed moisture content (SMC) measuring apparatus, wherein the SMC measuring apparatus comprises: an enclosure; a seed cup attachable to an attachment ring extending from an opening within a first panel of the enclosure; a display screen within a second panel of the enclosure; a sensor fixture within the enclosure, wherein the sensor fixture is oriented over the seed cup from within the enclosure, and wherein the sensor fixture comprises: a baseplate; a photodetector disposed at a center of the baseplate one or more light emitting diodes (LEDs) disposed around a periphery of the baseplate, wherein the one or more LEDs are oriented toward the seed cup; and a seed threshing apparatus, comprising a housing;
a threshing drum disposed within the housing; a vibrating screen disposed within the housing below the threshing drum; a mixing chamber disposed within the housing below the vibrating screen; a mixing paddle disposed within the housing below the vibrating screen; and a rotary valve disposed within the housing below the mixing paddle.

Example 12a is a system as in any of the examples, particularly example 11a, wherein the seed threshing apparatus further comprises a seed sample cup below the rotary valve and configured to attach to the sensor fixture.

Example 13a is a system as in any of the examples, particularly example 11a, wherein the display screen is a first display screen, and wherein the seed threshing apparatus further comprises a second display screen disposed on the housing.

Example 14a is a system as in any of the examples, particularly example 11a, wherein the vibrating screen comprises a plurality of screens in a stack, wherein individual screens of the plurality of screens have different mesh sizes.

Example 15a is a method comprising obtaining a plurality of seed heads from a grass species; feeding the plurality of seed heads to a portable seed threshing apparatus, wherein the housing; a vibrating screen disposed within the housing below the threshing drum; a mixing chamber disposed within the housing below the vibrating screen; a mixing paddle disposed within the housing below the vibrating screen; a rotary valve disposed within the housing below the mixing paddle; and a seed sample cup below the rotary valve; and filling the seed sample cup with seeds to a predetermined depth.

Example 16a is a method as in any of the examples, particularly example 15a, further comprising: attaching the seed sample cup to a portable seed moisture content (SMC) readout console, wherein the SMC readout console comprises: an enclosure; a seed cup attachable to an attachment ring extending from an opening within a first panel of the enclosure; a display screen within a second panel of the enclosure; and a sensor fixture within the enclosure.

Example 17a is a method as in any of the examples, particularly example 16a, further comprising initiating a SMC reading, wherein a user input is given to the display screen of the SMC readout console.

Example 18a is a method as in any of the examples, particularly example 17a, further comprising initiating a SMC reading, wherein a user input is given to the display screen of the SMC readout console.

Example 19a is a method as in any of the examples, particularly example 18a, wherein obtaining the harvest timing reading comprises reading the harvest timing reading wirelessly by a local computing device or by a cloud computing device.

Example 20a is a method as in any of the examples, particularly example 18a, wherein initiating the SMC reading comprises activating a touch screen on the SMC readout console.

Besides what is described herein, various modifications can be made to disclosed embodiments and embodiments thereof without departing from their scope. Therefore, illustrations of embodiments herein should be construed as examples, and not restrictive to scope of present disclosure.

We claim:

1. An apparatus for measuring seed moisture content (SMC), comprising:
an enclosure;
a seed cup attachable to an attachment ring extending from an opening within a first panel of the enclosure;
a display screen within a second panel of the enclosure, wherein the second panel opposes the first panel; and
a sensor fixture within the enclosure, wherein the sensor fixture is oriented over the seed cup from within the enclosure, and wherein the sensor fixture comprises:
a baseplate;
a photodetector disposed at a center of the baseplate; and
one or more light emitting diodes (LEDs) disposed around a periphery of the baseplate, wherein the one or more LEDs are oriented toward the seed cup.

2. The apparatus of claim 1, further comprising an electronic control circuit within the enclosure, wherein the electronic control circuit is coupled to the display screen and to the one or more LEDs.

3. The apparatus of claim 2, wherein the electronic control circuit comprises a processor, wherein the processor is coupled to a wifi module, a Bluetooth module, and a display driver.

4. The apparatus of claim 3, wherein the display driver is coupled to the display screen.

5. The apparatus of claim 1, wherein the display screen is a touch screen.

6. The apparatus of claim 3, wherein the processor is coupled to a LED driver and to the photodetector, wherein the photodetector is configured to receive a light signal reflected from a plurality of seeds within the seed cup, wherein the light signal is emitted from the one or more LEDs in the sensor fixture, and wherein the processor reads an output of the photodetector when the photodetector receives the reflected light from the one or more LEDs and converts the output of the photodetector to a seed moisture content.

7. The apparatus of claim 1, wherein the one or more LEDs are oriented at an angle ranging between 45 and 70 degrees with respect to the baseplate.

8. The apparatus of claim 1, wherein seed cup comprises a rim, wherein the rim comprises one or more tabs, wherein the one or more tabs are configured to engage within one or more slots oriented around an opening in the first panel for attachment of the seed cup to the enclosure.

9. The apparatus of claim 1, wherein the enclosure has a gaming console geometry, wherein the first panel and the second panel have a substantially trapezoidal geometry, wherein the first panel and the second panel each have a first lobe extending from first corner and a second lobe extending from a second corner, and wherein the first corner and the second corner are adjacent to one another.

10. The apparatus of claim 1, wherein one or more the LEDs comprise a first set of LEDs and a second set of LEDs, wherein individual LEDs of the first set of LEDs have a first spectral output, wherein individual LEDs of the second set of LEDs have a second spectral output and wherein the first spectral output is combined with the second spectral output to cover a spectrum ranging between at least 1200 nm to 1500 nm.

11. A system, comprising:
a seed moisture content (SMC) measuring apparatus, wherein the SMC measuring apparatus comprises:
an enclosure;
a seed cup attachable to an attachment ring extending from an opening within a first panel of the enclosure;
a display screen within a second panel of the enclosure;
a sensor fixture within the enclosure, wherein the sensor fixture is oriented over the seed cup from within the enclosure, and wherein the sensor fixture comprises:
a baseplate;
a photodetector disposed at a center of the baseplate one or more light emitting diodes (LEDs) disposed around a periphery of the baseplate, wherein the one or more LEDs are oriented toward the seed cup; and
a seed threshing apparatus, comprising
a housing;
a threshing drum disposed within the housing;
a vibrating screen disposed within the housing below the threshing drum;
a mixing chamber disposed within the housing below the vibrating screen;
a mixing paddle disposed within the housing below the vibrating screen; and
a rotary valve disposed within the housing below the mixing paddle.

12. The system of claim 11, wherein the seed threshing apparatus further comprises a seed sample cup below the rotary valve and configured to attach to the sensor fixture.

13. The system of claim 11, wherein the display screen is a first display screen, and wherein the seed threshing apparatus further comprises a second display screen disposed on the housing.

14. The system of claim 11, wherein the vibrating screen comprises a plurality of screens in a stack, wherein individual screens of the plurality of screens have different mesh sizes.

15. A method, comprising:
obtaining a plurality of seed heads from a grass species;
feeding the plurality of seed heads to a portable seed threshing apparatus, wherein the portable seed threshing apparatus comprises:
a housing;
a threshing drum disposed within the housing;
a vibrating screen disposed within the housing below the threshing drum;
a mixing chamber disposed within the housing below the vibrating screen;
a mixing paddle disposed within the housing below the vibrating screen;
a rotary valve disposed within the housing below the mixing paddle; and
a seed sample cup below the rotary valve; and
filling the seed sample cup with seeds to a predetermined depth.

16. The method of claim 15, further comprising:
attaching the seed sample cup to a portable seed moisture content (SMC) readout console, wherein the SMC readout console comprises:
an enclosure;
a seed cup attachable to an attachment ring extending from an opening within a first panel of the enclosure;
a display screen within a second panel of the enclosure; and
a sensor fixture within the enclosure.

17. The method of claim 16, further comprising initiating a SMC reading, wherein a user input is given to the display screen of the SMC readout console.

18. The method of claim 17, further comprising initiating a SMC reading, wherein a user input is given to the display screen of the SMC readout console.

19. The method of claim 18, wherein obtaining the harvest timing reading comprises reading the harvest timing reading wirelessly by a local computing device or by a cloud computing device.

20. The method of claim 18, wherein initiating the SMC reading comprises activating a touch screen on the SMC readout console.
